(19) United States
(12) Patent Application Publication
(10) Pub. No.: US 2017/0357087 A1
(43) Pub. Date: Dec. 14, 2017

(54) OPTICAL PROTECTION ELEMENT REPLACEMENT SYSTEM OF THE SECURITY CAMERA DEVICE AND METHOD THEREOF

(71) Applicant: AV TECH CORPORATION, Taipei City (TW)

(72) Inventor: CHUN-RU HUANG, Taipei City (TW)

(21) Appl. No.: 15/432,090

(22) Filed: Feb. 14, 2017

(30) Foreign Application Priority Data
Jun. 14, 2016 (CN) 201610415371.5

(51) Int. Cl. G02B 27/00; H04N 7/18; G06K 9/62

(52) U.S. Cl. CPC G02B 27/0006; G06K 9/6202; H04N 7/183

(57) ABSTRACT

Provided herein is an optical protection element replacement system of a security camera device, including a security camera device and a replacement device. The lens of the security camera device is covered by a part of an elastic optical protection element. The processing unit compares the captured images with a preset condition, and generates a driving signal if the captured image does not match the preset condition. The replacement device includes a retrieving module and a dispensing module. The retrieving module pulls back a preset length of the elastic optical protection element based on the driving signal. The dispensing module accommodates and dispenses the elastic optical protection element. Therefore, the front side of the security camera device stays clean so that it may continuously provide high quality images. Further equivalent methods are also provided for the same purpose.

### CROSS-REFERENCE TO RELATED APPLICATION

This application claims priority from China Patent Application No. 201610415371.5, filed on Jun. 14, 2016 at the State Intellectual Property Office of the P.R.C., the content of which is hereby incorporated by reference in its entirety for all purposes.

### BACKGROUND OF THE INVENTION

### 1. Field of the Invention

The present invention relates to replacement systems of optical protection elements and methods thereof. More particularly, the present invention relates to replacement systems of an optical protection element of a security camera device and methods thereof, which may automatically replace the elastic optical protection element that covers the lens of the security camera device.

### 2. Description of the Related Art

Conventionally, a security camera device is installed at a high place in order to get as full of a view of the monitored area as possible.

Because of its position, it is inconvenient to check the condition of the camera lens or to clean it. As a result, the lens is usually not clean, and only when it is too dirty to provide readable images, will the operator notice it and clean it. Due to the inability to always maintain its cleanness and to continuously provide high quality images, the security camera device will often perform with low fidelity.

### SUMMARY OF THE INVENTION

The present invention provides a replacement system of an optical protection element of a security camera device and a method thereof to deal with the aforementioned technical issue.

Provided herein is a replacement system of an optical protection element of a security camera device, including a security camera device and a replacement device. The security camera device includes an image capturing unit and a processing unit. The lens of the security camera device is covered by a part of an elastic optical protection element. The image capturing unit is utilized to capture images. These captured images are then sent to the processing unit. The processing unit compares the captured images with a preset condition, and generates a driving signal if the captured image does not match the preset condition. The replacement device, which is disposed on the front rim of the security camera device, includes a retrieving module and a dispensing module. The retrieving module, which is disposed on the front rim of the security camera device, connects to an end of the part of the elastic optical protection element that covers the camera lens and pulls back a preset length of the elastic optical protection element based on the driving signal. The dispensing module, which is disposed on the front rim of the security camera device opposing to the retrieving module, accommodates the elastic optical protection element and dispenses the elastic optical protection element due to the pulling force exerted by the retrieving module based on the driving signal.

Preferably, the processing unit may generate image information of the monitoring image and compare the image information with the preset condition. If the image information of the monitoring image does not match the preset condition, the processing unit generates the driving signal.

Preferably, the processing unit may generate a warning message based on the driving signal and transmit the warning message to a remote device.

Preferably, the dispensing module may dispense a preset length of the elastic optical protection element based on the driving signal.

Preferably, the preset length may be equal to or longer than the diameter of the lens.

Also provided herein is a replacement method of an optical protection element of a security camera device. The method is applicable to the replacement system of an optical protection element of a security camera device, which may include a security camera device and a replacement device. The security camera device may include an image capturing unit and a processing unit, and the replacement device may include a retrieving module and a dispensing module. The replacement method of the optical protection element of the security camera device includes the steps of: capturing a monitoring image; comparing the monitoring image with a preset condition; generating a driving signal when the monitoring image does not meet the preset condition; retrieving a preset length of an elastic optical protection element based on the driving signal.

Preferably, at the step of comparing the monitoring image and the preset condition, the replacement method of the optical protection element of the security camera device may further include the steps of: generating image information from the monitoring image; comparing the image information with a preset condition; generating a driving signal when the image information does not meet the preset condition.

Preferably, at the step of generating the driving signal, the replacement method of the optical protection element of the security camera device may further include the steps of: generating a warning message based on the driving signal; transmitting the warning message to a remote device.

Preferably, at the step of generating the driving signal, the replacement method of the optical protection element of the security camera device may further include the steps of: dispensing the preset length of the elastic optical protection element based on the driving signal.

Preferably, a part of the elastic optical protection element may cover the lens of the security camera device, and the preset length is equal to or longer than the diameter of the lens.

In summary, the replacement system of the optical protection element of the security camera device of the present invention and the method is thereof is able to identify whether the part of the elastic optical protection element is contaminated or not by using the processing unit to check if the monitoring image is different from the preset condition, and then drive the retrieving module to pull back the preset length of the optical protection element so as to cover the lens with a clean one. By detecting and eliminating the contamination present in front of the lens in this way, the quality of the monitoring images can be maintained.

### BRIEF DESCRIPTION OF THE DRAWINGS

FIG. 1 is a first block diagram showing a replacement system of an optical protection element of a security camera device of the present invention.

FIG. 2 is a second block diagram showing a replacement system of an optical protection element of a security camera device of the present invention.

FIG. 3 is a schematic diagram showing a replacement system of an optical protection element of a security camera device of the present invention.

FIG. 4 is a flow chart showing a replacement method of an optical protection element of a security camera device of the present invention.

### DESCRIPTION OF THE PREFERRED EMBODIMENTS

The technical features, content, advantages and effects of the present invention will be presented hereinafter through embodiments accompanied with corresponding figures. The figures are only for the purpose of illustration and example, and do not necessarily imply the actual dimensions or precise configuration of the possible implementations of the present invention. Therefore, the present invention should not be limited by the dimensions or configuration shown in the figures.

The advantages, features, and approaches of the present invention will be described in detail with embodiments and their corresponding figures. The present invention can also be approached in different ways and should not be considered to be limited by these embodiments. For those skilled in the art, the scope of the present invention can be more clearly, thoroughly, and completely delivered through these embodiments; however, the present invention is limited solely by the scope of the appended claims.

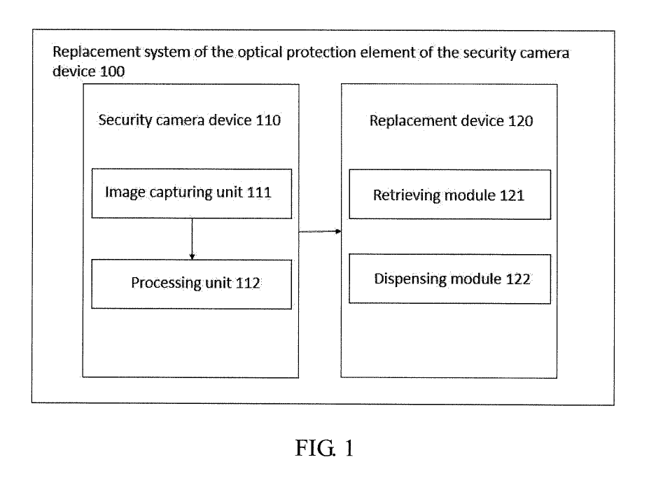

The following refers to FIG. 1, which is a first block diagram showing a replacement system of an optical protection element of a security camera device of the present invention. As shown in the figure, the replacement system of the optical protection element of a security camera device 100 includes a security camera device 110 and a replacement device 120, wherein the security camera device 110 and the replacement device 120 are electrically connected with one another.

In addition, the security camera device 110 includes an image capturing unit 111 and a processing unit 112. The image capturing unit 111 is utilized to capture monitoring images within the monitoring range of the security camera device 110. The monitoring images are received by the processing unit 112, and then compared to a preset condition by the processing unit 112. The processing unit 112 checks if the monitoring images match the preset condition. The preset condition can be built-in and stored in the processing unit 112, can be adjusted based on environmental conditions, or can be adjusted according to specific user requirements. The processing unit 112 generates a driving signal when the monitoring image does not meet the preset condition.

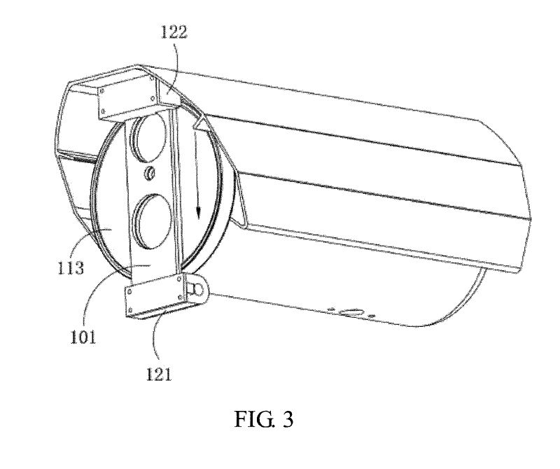

The reason for the mismatch is that, when a part of the elastic optical protection element 101, as shown in FIG. 3, that covers a lens 113 of the security camera device 110 is contaminated, the captured image either shows the contaminants themselves (particles, stains, etc.) or is entirely blurred. The preset condition may serve as a standard image, and the standard image may be the image captured immediately prior to the monitoring image. If, on comparing, there is a difference between the monitoring image and the standard image, then there is an anomaly in front of the lens 113. In the step of comparing the two images, the monitoring image is calculated and analyzed by the processing unit 112 using an algorithm, and is then compared to the preset condition in order to check if they match.

If the monitoring image does not match the preset condition, that means a part of the elastic optical protection element 101 covering the lens 113 in front of the security camera device 110 is contaminated and requires changing by using the replacement device 120. For the change, the contaminated elastic optical protection element 101 is pulled back, and the lens 113 is covered with a clean elastic optical protection element 101.

The change of elastic optical protection element 101 is as follows. The replacement device 120 is disposed on the front rim of the security camera device 110. The processing unit 112 generates the driving signal, which is then received by the replacement device 120. The replacement device 120 includes a retrieving module 121 and a dispensing module 122. The retrieving module 121 is disposed on the front rim of the security camera device 110 and is connected to an end of the part of the elastic optical protection element 101 that covers the lens. The dispensing module 122 is disposed on the front rim of the security camera device 110 opposite to the retrieving module 121 and accommodates the elastic optical protection element 101. Based on the driving signal, the retrieving module 121 pulls back a preset length of the elastic optical protection element 101 with a force that also draws out the elastic optical protection element 101 from the dispensing module 122. Furthermore, while being pulled by the retrieving module 121, the preset length of the elastic optical protection element 101 may also be dispensed by the dispensing module 122 as well.

Alternatively, after receiving the monitoring image, the processing unit 112 may first generate image information of the monitoring image and then compare the image information with the preset condition. When the image information that does not match the preset condition, the processing unit 112 generates the driving signal. In particular, the image information may be a parameter such as sharpness, which is utilized to identify if the monitoring image is blurred or if contaminants have been captured in the monitoring image. Based on the result of such a determination, the replacement device 120 may be driven to pull back and replace the elastic optical protection element 101.

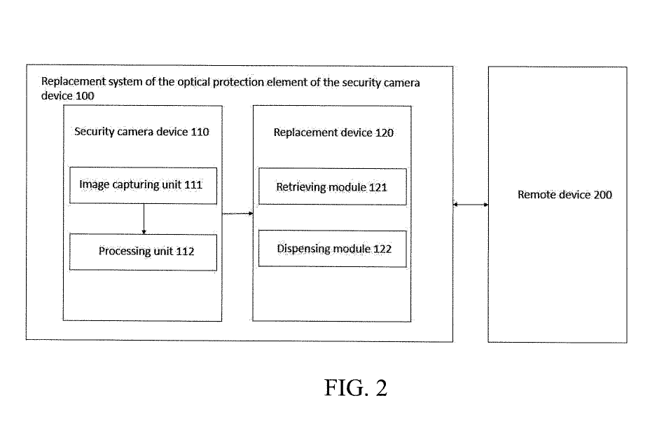

The following refers to FIG. 2, which is a second block diagram showing a replacement system of an optical protection element of a security camera device of the present invention. As shown in the figure, the replacement system of the optical protection element of the security camera device 100 of the present invention may be connected, including internet connected, to a remote device 200. Based on the driving signal, the processing unit 112 may generate and send a warning message to the remote device 200. For example, the warning message may be an indication light, a sound, a text, or a combination thereof for an operator of the remote device 200 to be notified that the elastic optical protection element 101 is contaminated. Moreover, if above a certain number of driving signals are generated during a preset period of time, then this indicates that the clean elastic optical protection element 101 in the dispensing module 122 may be used up, and therefore the retrieving module 121 is no longer able to pull back a clean elastic optical protection element 101, or the replacement device 120 may not be functioning. In this situation, the processing unit 112 may send a warning message to the remote device 200 to inform the operator of the remote device 200 that a further system checkup is required. In particular, the remote device 200 may set up the preset condition in the processing unit 112.

The following refers to FIG. 3, which is a schematic diagram showing a replacement system of an optical protection element of a security camera device of the present invention. As shown in the figure, the security camera device 110 may be a bullet security camera device, on the front rim of which are disposed opposite to each other the retrieving module 121 and dispensing module 122. The aforementioned preset length is preferably equal to or longer than the diameter of the lens, such that the part of the elastic optical protection element 101 that covers the lens may be completely retrieved.

In the above description of the replacement system of the optical protection element of the security camera device of the present invention, the concept of the replacement method has already been described. Hereinafter, the flow chart of the method is described.

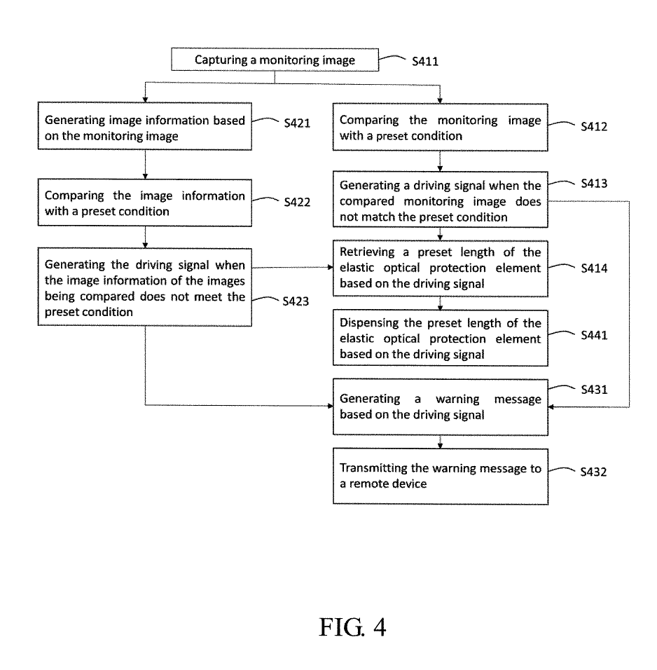

The following refers to FIG. 4, which is a flow chart representing a replacement method of an optical protection element of a security camera device of the present invention. As shown in the figure, the replacement method of the optical protection element of the security camera device of the present invention is applicable to the replacement system of the optical protection element of the security camera device 100 of the present invention, which includes a security camera device and a replacement device. The security camera device may include an image capturing unit and a processing unit. The replacement method of the optical protection element of the security camera device of the present invention includes:

A step S411 of capturing a monitoring image. The monitoring image is acquired by the image capturing unit taking an image in the monitoring range of the security camera device.

A step S412 of comparing the monitoring image with a preset condition. The step is performed after the processing unit of the security camera device receives the monitoring image. It is however not necessary to compare all the monitoring images by the processing unit, rather the comparison can be performed at preset time intervals.

A step S413 of generating a driving signal when the compared monitoring image does not match the preset condition. The driving signal is generated after a non-matching result in the comparison by the processing unit.

A step S414 of retrieving a preset length of the elastic optical protection element based on the driving signal. By retrieving the contaminated elastic optical protection element and covering the lens with the clean elastic optical protection element, the front end of the security camera device, including the lens, may be kept clean.

Also note that, when the driving signal is generated, the preset length of elastic optical protection element may be dispensed based on the driving signal in a step S441. This step therefore includes dispensing the elastic optical protection element by a dispensing module and retrieving the elastic optical protection element by a retrieving module.

Specifically, a part of the elastic optical protection element covers the lens of the security camera device, and the preset length is equal to or longer than the diameter of the lens.

Additionally, the comparison between the monitoring image and the preset condition may further include:

A step S421 of generating image information based on the monitoring image. The image information may be acquired by calculating and/or analyzing the monitoring image using algorithms or image processing techniques.

A step S422 of comparing the image information with the preset condition.

A step S423 of generating the driving signal when the image information of the images being compared does not meet the preset condition. In this step, the image information of the monitoring image is utilized for to determine whether to generate the drive signal.

Additionally, the replacement method of the optical protection element of the security camera device of the present invention may further include:

A step S431 of generating a warning message based on the driving signal. The warning message is generated by the processing unit.

A step S432 of transmitting the warning message to a remote device.

The detailed description and the practical embodiments of the replacement method of the present invention have already been covered in the previous description of the replacement system of the optical protection element of the security camera device of the present invention. They are therefore omitted here for conciseness.

In summary, the replacement system of the optical protection element of the security camera device of the present invention is able to identify when a part of the elastic optical protection element is contaminated based on the monitoring image by the processing unit, and then drives the retrieving module to pull back a preset length of the elastic optical protection element so as to cover the lens with a clean elastic optical protection element. Therefore, by preventing contamination from obscuring the lens, the quality of the monitoring image can be preserved.

The purpose of described embodiments is to illustrate the technical ideas and features of the present invention, such that one skilled in the art can comprehend the contents of the present invention and practice said invention accordingly. It should be understood, however, that the invention is not to be limited to the particular form disclosed; rather, the invention is to cover all modifications, equivalents, and alternatives falling within the spirit and scope of the appended claims.

What is claimed is:

1. A replacement system of an optical protection element of a security camera device, comprising:
a security camera device, a lens of which is covered by a part of an elastic optical protection element, comprising:
an image capturing unit capturing a monitoring image; and
a processing unit receiving the monitoring image and comparing the monitoring image with a preset condition, wherein the processing unit generates a driving signal if the monitoring image does not match the preset condition; and
a replacement device disposed on a front rim of the security camera device, comprising:
a retrieving module disposed on the front rim of the security camera device and connected to an end of the part of the elastic optical protection element that covers the camera lens, wherein the retrieving module pulls back a preset length of the elastic optical protection element based on the driving signal; and
a dispensing module disposed on the front rim of the security camera device opposite to the retrieving module and accommodating the elastic optical protection element, wherein the dispensing module dispenses the elastic optical protection element due to the pulling force exerted by the retrieving module based on the driving signal.

2. The replacement system of the optical protection element of the security camera device of claim 1, wherein the processing unit generates image information of the monitoring image and compares the image information with the preset condition, and the processing unit generates the driving signal if the image information of the monitoring image does not match the preset condition.

3. The replacement system of the optical protection element of the security camera device of claim 1, wherein the processing unit generates a warning message based on the driving signal and transmits the warning message to a remote device.

4. The replacement system of an optical protection element of a security camera device of claim 1, wherein the dispensing module dispenses the preset length of the elastic optical protection element based on the driving signal.

5. The replacement system of the optical protection element of the security camera device of claim 1, wherein the preset length is equal to or longer than the diameter of the lens.

6. A replacement method of an optical protection element of a security camera device applicable to a replacement system of the optical protection element of the security camera device; the replacement system comprising a security camera device and a replacement device, the security camera device comprising an image capturing unit and a processing unit, the replacement device comprising a retrieving module and a dispensing module; and the replacement method comprising the steps of:
capturing a monitoring image;
comparing the monitoring image with a preset condition;
generating a driving signal when the monitoring image does not match the preset condition; and
retrieving a preset length of the elastic optical protection element based on the driving signal.

7. The replacement method of the optical protection element of the security camera device of claim 6, wherein at the step of comparing the monitoring image with the preset condition, the method further comprises the steps of:
generating image information from the monitoring image;
comparing the image information with the preset condition;
generating the driving signal when the image information does not match the preset condition.

8. The replacement method of the optical protection element of the security camera device of claim 6, wherein at the step of generating the driving signal, the method further comprises the steps of:
generating a warning message based on the driving signal; and
transmitting the warning message to a remote device.

9. The replacement method of the optical protection element of the security camera device of claim 6, wherein at the step of generating the driving signal, the method further comprises the step of:
dispensing the preset length of the elastic optical protection element based on the driving signal.

10. The replacement method of the optical protection element of the security camera device of claim 6, wherein a part of the elastic optical protection element covers a lens of the security camera device, and the preset length is equal to or longer than the diameter of the lens.
